(19) United States
(12) Patent Application Publication
(10) Pub. No.: US 2020/0282947 A1
(43) Pub. Date: Sep. 10, 2020

(54) WEBBING TAKE-UP DEVICE

(71) Applicant: KABUSHIKI KAISHA TOKAI-RIKA-DENKI-SEISAKUSHO, Aichi (JP)

(72) Inventors: Tomoya OWAKI, Aichi (JP); Kazuhiro YAMADA, Aichi (JP)

(21) Appl. No.: 16/644,687

(22) PCT Filed: Sep. 6, 2018
(86) PCT No.: PCT/JP2018/033077

§ 371 Date: Mar. 5, 2020

(30) Foreign Application Priority Data
Sep. 12, 2017 (JP) 2017-174818

(51) Int. Cl. B60R 22/343; B60R 22/38

(52) U.S. Cl. CPC B60R 22/343; B60R 22/38

(57) ABSTRACT

In a webbing take-up device, in a case in which the acceleration with which a webbing is pulled out from a spool, which is based on the radius of the webbing taken up on the spool and the angular acceleration of rotation of the spool in the pull-out direction that are detected by an angle-of-rotation sensor, is equal to or greater than a predetermined acceleration, a lock mechanism locks the rotation of the spool in the pull-out direction. For this reason, the rotation of the spool can be locked on based on the acceleration with which the webbing is pulled out from the spool.

### TECHNICAL FIELD

The present invention relates to a webbing take-up device in which a webbing worn by an occupant is taken up on a spool.

### BACKGROUND ART

In the webbing take-up device disclosed in JP-A No. 2014-136451, a webbing is taken up on a spool, and in a case in which the angular acceleration of rotation of the spool in a pull-out direction is equal to or greater than a predetermined angular acceleration, a W-pawl of a lock mechanism is activated and the lock mechanism locks the rotation of the spool.

Here, in this webbing take-up device, when the radius of the webbing taken up on the spool fluctuates in a case in which the acceleration with which the webbing is pulled out from the spool is the same, the angular acceleration of rotation of the spool in the pull-out direction fluctuates.

### SUMMARY OF INVENTION

### Technical Problem

In consideration of the above circumstances, it is an object of the present invention to obtain a webbing take-up device that can lock the rotation of the spool on based on the acceleration with which the webbing is pulled out from the spool.

### Solution to Problem

A webbing take-up device of a first aspect of the invention includes: a spool on which webbing worn by an occupant is taken up and which is rotated in a pull-out direction when the webbing is pulled out; and a lock mechanism that locks rotation of the spool in a case in which an acceleration with which the webbing is pulled out from the spool is equal to or greater than a predetermined acceleration.

A webbing take-up device of a second aspect of the invention is the webbing take-up device of the first aspect of the invention, wherein the acceleration with which the webbing is pulled out from the spool is detected based on a radius of the webbing taken up on the spool and an angular acceleration of rotation of the spool in the pull-out direction.

A webbing take-up device of a third aspect of the invention is the webbing take-up device of the first aspect or the second aspect of the invention, further including a detector that detects an angle of rotation of the spool, whereby at least one of a radius of the webbing taken up on the spool or an angular acceleration of rotation of the spool in the pull-out direction is detected.

A webbing take-up device of a fourth aspect of the invention is the webbing take-up device of any one of the first aspect to the third aspect of the invention, further including a detector that detects light from at least one of the spool or the webbing, whereby at least one of a radius of the webbing taken up on the spool, an angular acceleration of rotation of the spool in the pull-out direction, or the acceleration with which the webbing is pulled out from the spool is detected.

### Advantageous Effects of Invention

In the webbing take-up device of the first aspect of the invention, the webbing worn by the occupant is taken up on the spool, and the spool is rotated in the pull-out direction when the webbing is pulled out from the spool.

Here, in a case in which the acceleration with which the webbing is pulled out from the spool is equal to or greater than the predetermined acceleration, the lock mechanism locks the rotation of the spool. For this reason, the rotation of the spool can be locked on based on the acceleration with which the webbing is pulled out from the spool.

In the webbing take-up device of the second aspect of the invention, the acceleration with which the webbing is pulled out from the spool is detected on based on the radius of the webbing taken up on the spool and the angular acceleration of rotation of the spool in the pull-out direction. For this reason, the acceleration with which the webbing is pulled out from the spool can be easily detected.

In the webbing take-up device of the third aspect of the invention, the detector detects the angle of rotation of the spool, whereby at least one of the radius of the webbing taken up on the spool or the angular acceleration of rotation of the spool in the pull-out direction is detected. For this reason, at least one of the radius of the webbing taken up on the spool or the angular acceleration of rotation of the spool in the pull-out direction can be easily detected.

In the webbing take-up device of the fourth aspect of the invention, the detector detects light from at least one of the spool or the webbing, whereby at least one of the radius of the webbing taken up on the spool, the angular acceleration of rotation of the spool in the pull-out direction, or the acceleration with which the webbing is pulled out from the spool is detected. For this reason, at least one of the radius of the webbing taken up on the spool, the angular acceleration of rotation of the spool in the pull-out direction, or the acceleration with which the webbing is pulled out from the spool can be easily detected.

### BRIEF DESCRIPTION OF DRAWINGS

FIG. 1 is an exploded perspective view, seen obliquely from the front and left, showing a webbing take-up device pertaining to an embodiment of the invention.

FIG. 2 is a sectional view, seen from the left, showing the webbing take-up device pertaining to the embodiment of the invention.

### DESCRIPTION OF EMBODIMENT

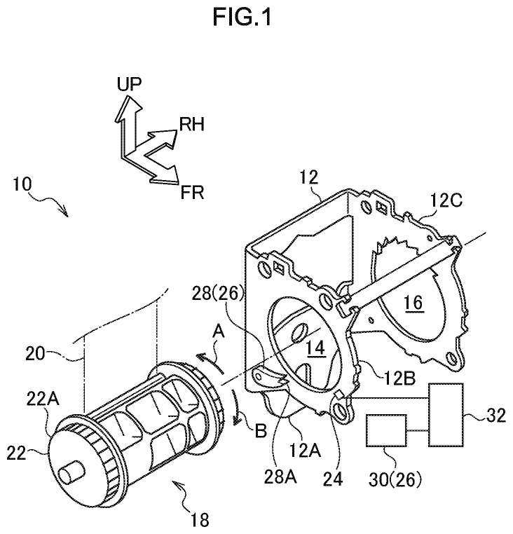

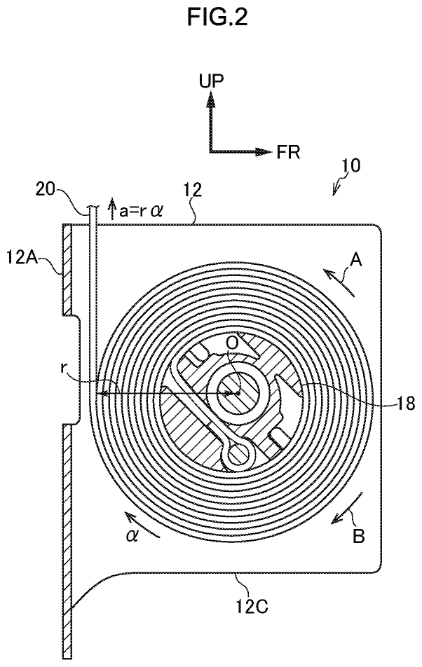

In FIG. 1 a webbing take-up device 10 pertaining to an embodiment of the invention is shown in an exploded perspective view seen obliquely from the front and left, and in FIG. 2 the webbing take-up device 10 is shown in a sectional view seen from the left. It will be noted that in the drawings arrow FR indicates the front direction of the webbing take-up device 10, arrow RH indicates the right direction of the webbing take-up device 10, and arrow UP indicates the up direction of the webbing take-up device 10.

As shown in FIG. 1 and FIG. 2, the webbing take-up device 10 pertaining to the embodiment is equipped with a U-shaped plate-like frame 12, and the frame 12 is provided with a back plate 12A on the rear side, a leg plate 12B on the left side, and a leg plate 12C on the right side. The back plate 12A is anchored to a vehicle body, whereby the webbing take-up device 10 is anchored to the vehicle body. A through hole 14 and a through hole 16 are formed through the leg plate 12B and the leg plate 12C, respectively, and the through hole 14 and the through hole 16 are coaxially disposed.

A substantially cylindrical spool 18 is rotatably supported between the through hole 14 in the leg plate 12B and the through hole 16 in the leg plate 12C, and a base end portion of a long band-like webbing 20 is anchored to the spool 18. The webbing 20 is taken up on the spool 18 when the spool 18 is rotated in a take-up direction (one direction about its axis; the direction of arrow A in FIG. 1 and FIG. 2), and the spool 18 is rotated in a pull-out direction (the other direction about its axis; the direction of arrow B in FIG. 1 and FIG. 2) when the webbing 20 is pulled out from the spool 18. The webbing 20 is pulled out upward from the spool 18, and the webbing 20 is configured to be wearable by an occupant of the vehicle.

A substantially disc-shaped lock gear 22 serving as a lock counterpart component is coaxially provided on the left end portion of the spool 18, and the lock gear 22 projects on the left side of the leg plate 12B via the through hole 14 in the leg plate 12B. The lock gear 22 is configured to be integrally rotatable with the other portion of the spool 18, and ratchet teeth 22A are formed along the entire circumference of the lock gear 22.

An angle-of-rotation sensor 24 serving as a detector is provided in, for example, the frame 12, and the angle-of-rotation sensor 24 detects the angle of rotation of the spool 18. For this reason, the angle-of-rotation sensor 24 is configured to be able to detect the direction of rotation, the angular velocity of rotation, and the angular acceleration of rotation (in particular, an angular acceleration a of rotation in the pull-out direction shown in FIG. 2) of the spool 18, the amount of the webbing 20 taken up on the spool 18, the amount of the webbing 20 pulled out from the spool 18, and a radius r of the webbing 20 taken up on the spool 18 (the radius of the spool 18 and the webbing 20 at the position where the webbing 20 is pulled out from the spool 18; see FIG. 2), and is configured to be able to detect the acceleration of the webbing 20 (in particular, an acceleration a with which the webbing 20 is pulled out from the spool 18, shown in FIG. 2). It will be noted that in FIG. 2 reference sign O denotes the central axis of rotation of the spool 18.

A biasing mechanism (not shown in the drawings) is provided on the right side of the leg plate 12C, and the biasing mechanism is mechanically connected to the spool 18. The biasing mechanism biases the spool 18 in the take-up direction, and when the webbing 20 is being worn by the occupant, the webbing 20 is acted upon by a force that takes it up on the spool 18 because of the biasing force of the biasing mechanism, whereby slack in the webbing 20 is eliminated.

An electric lock mechanism 26 is provided on the left side of the leg plate 12B. The lock mechanism 26 is provided with a plate-like lock pawl 28 serving as a lock component, and the lock pawl 28 is supported at its base end portion so as to be pivotable in a predetermined range on the left side of the leg plate 12B. Lock teeth 28A are formed on a distal end portion of the lock pawl 28, and the lock teeth 28A are spaced apart, on the radial direction outer side of the lock gear 22, from the ratchet teeth 22A of the lock gear 22.

The lock mechanism 26 is provided with an activation device 30, and when the activation device 30 is electrically activated, the lock pawl 28 is pivoted toward the lock gear 22 (inward in the radial direction of the lock gear 22) by biasing force to cause the lock teeth 28A of the lock pawl 28 to mesh with the ratchet teeth 22A of the lock gear 22. For this reason, rotation of the lock gear 22 in the pull-out direction is locked and rotation of the spool 18 in the pull-out direction is locked.

It will be noted that when the spool 18 is rotated in the take-up direction in a state in which the lock teeth 28A of the lock pawl 28 are meshed with the ratchet teeth 22A of the lock gear 22, the lock teeth 28A of the lock pawl 28 are moved by the ratchet teeth 22A of the ratchet gear 22, and the lock pawl 28 is pivoted in the opposite direction of the lock gear 22 (outward in the radial direction of the lock gear 22) counter to the biasing force of the activation device 30. For this reason, rotation of the lock gear 22 in the take-up direction is allowed and rotation of the spool 18 in the take-up direction is allowed.

The angle-of-rotation sensor 24 and the activation device 30 of the lock mechanism 26 are electrically connected to a control device 32 serving as a control component.

Next, the action of the embodiment will be described.

In the webbing take-up device 10 with the above configuration, the webbing 20 is pulled out from the spool 18 and worn by the occupant. At this time, the webbing 20 is acted upon by a force that takes it up on the spool 18 because of the biasing force of the biasing mechanism, whereby slack in the webbing 20 is eliminated.

At the time of an impact to the vehicle (at the time of an emergency (a predetermined occasion)), the webbing 20 is abruptly pulled by the occupant and the webbing 20 is abruptly pulled out from the spool 18, whereby the activation device 30 of the lock mechanism 26 is electrically activated by control of the control device 32. For this reason, the activation device 30 causes the lock pawl 28 to pivot toward the lock gear 22 and causes the lock teeth 28A of the lock pawl 28 to mesh with the ratchet teeth 22A of the lock gear 22, whereby rotation of the lock gear 22 in the pull-out direction is locked and rotation of the spool 18 in the pull-out direction is locked. Because of this, the pulling-out of the webbing 20 from the spool 18 is locked and the occupant is restrained by the webbing 20.

Here, in a case in which the acceleration a with which the webbing 20 is pulled out from the spool 18, which is based on the radius r of the webbing 20 taken up on the spool 18 and the angular acceleration a of rotation of the spool 18 in the pull-out direction that are detected by the angle-of-rotation sensor 24, is equal to or greater than a predetermined acceleration, the lock mechanism 26 locks the rotation of the spool 18 in the pull-out direction because of the control of the control device 32. For this reason, the rotation of the spool 18 in the pull-out direction can be locked on based on the acceleration a with which the webbing 20 is pulled out from the spool 18, and the occupant can be restrained by the webbing 20. Because of this, even in a case in which the acceleration a with which the webbing 20 is pulled out from the spool 18 is the same, the activation threshold of the lock mechanism 26 can be inhibited from fluctuating as a result of the radius r of the webbing 20 taken up on the spool 18 fluctuating due to differences in the physique of the occupant and the angular acceleration a of rotation in the pull-out direction from the spool 18 fluctuating, and the occupant restraint performance of the webbing 20 can be inhibited from varying due to the physique of the occupant.

Furthermore, the radius r of the webbing 20 taken up on the spool 18 and the angular acceleration a of rotation of the spool 18 in the pull-out direction are detected by the angle-of-rotation sensor 24, whereby the acceleration a with which the webbing 20 is pulled out from the spool 18 is detected. For this reason, the acceleration a with which the webbing 20 is pulled out from the spool 18 can be easily detected.

Moreover, the angle of rotation of the spool 18 is detected by the angle-of-rotation sensor 24, whereby the radius r of the webbing 20 taken up on the spool 18 and the angular acceleration a of rotation of the spool 18 in the pull-out direction are detected. For this reason, the radius r of the webbing 20 taken up on the spool 18 and the angular acceleration a of rotation of the spool 18 in the pull-out direction can be easily detected.

It will be noted that in this embodiment the radius r of the webbing 20 taken up on the spool 18 and the angular acceleration a of rotation of the spool 18 in the pull-out direction are detected by the angle-of-rotation sensor 24, whereby the acceleration a with which the webbing 20 is pulled out from the spool 18 is detected. However, an optical sensor (e.g., a camera) serving as a detector may also detect light from at least one of the spool 18 or the webbing 20 to thereby detect at least one of the radius r of the webbing 20 taken up on the spool 18, the angular acceleration a of rotation of the spool 18 in the pull-out direction, or the acceleration a with which the webbing 20 is pulled out from the spool 18.

The disclosure of Japanese Patent Application No. 2017-174818 filed on Sep. 12, 2017, is incorporated in its entirety by reference herein.

### REFERENCE SIGNS LIST

10 Webbing Take-up Device
18 Spool
20 Webbing
24 Angle-of-rotation Sensor (Detector)
26 Lock Mechanism

1.-5. (canceled)

6. A webbing take-up device comprising:
a spool on which webbing worn by an occupant is taken up and which is rotated in a pull-out direction when the webbing is pulled out; and
a lock mechanism that locks rotation of the spool in a case in which an acceleration with which the webbing is pulled out from the spool is equal to or greater than a predetermined acceleration,
wherein the acceleration with which the webbing is pulled out from the spool is detected based on a radius of the webbing taken up on the spool and an angular acceleration of rotation of the spool in the pull-out direction.

7. The webbing take-up device according to claim 6, further comprising a detector that detects an angle of rotation of the spool, whereby at least one of the radius of the webbing taken up on the spool or the angular acceleration of rotation of the spool in the pull-out direction is detected.

8. The webbing take-up device according to claim 6, further comprising a detector that detects light from at least one of the spool or the webbing, whereby at least one of the radius of the webbing taken up on the spool, the angular acceleration of rotation of the spool in the pull-out direction, or the acceleration with which the webbing is pulled out from the spool is detected.

9. The webbing take-up device according to any one of claim 6, wherein the lock mechanism is electrically activated.

10. A webbing take-up device comprising:
a spool on which webbing worn by an occupant is taken up and which is rotated in a pull-out direction when the webbing is pulled out; and
a lock mechanism that locks rotation of the spool in a case in which an acceleration with which the webbing is pulled out from the spool is equal to or greater than a predetermined acceleration; and
a detector that detects an angle of rotation of the spool, whereby at least one of a radius of the webbing taken up on the spool or an angular acceleration of rotation of the spool in the pull-out direction is detected.

11. The webbing take-up device according to claim 10, further comprising a detector that detects light from at least one of the spool or the webbing, whereby at least one of the radius of the webbing taken up on the spool, the angular acceleration of rotation of the spool in the pull-out direction, or the acceleration with which the webbing is pulled out from the spool is detected.

12. The webbing take-up device according to claim 10, wherein the lock mechanism is electrically activated.
